(19) United States
(12) Patent Application Publication
(10) Pub. No.: US 2006/0001284 A1
(43) Pub. Date: Jan. 5, 2006

(54) Rotating motor vehicle ornament

(76) Inventor: Gary J. Stephenson, Chester, NJ (US)

Correspondence Address: THOMAS J. GERMINARIO, ESQ., 154 ROUTE 206, CHESTER, NJ, 07930, US

(21) Appl. No.: 10/869,951

(22) Filed: Jun. 18, 2004

(51) Int. Cl. B60R 13/04

(52) U.S. Cl. 296/1.08

(57) ABSTRACT

A rotating motor vehicle ornament comprising three principal parts is disclosed. First, there is an ornament member consisting of an ornamental element and a base element on which the ornament is mounted. Attached to the bottom of the base element is the upper end of a shaft member, the lower end of which is coupled to a motor member, which is a means for imparting rotational motion through the shaft to the ornament member. Attached to the lower end of the motor member is an anchor member, the under side of which is an attachment element comprising a means of securing the anchor member to the body of a motor vehicle. In the preferred embodiment, the ornamental element is in the form of a wind-up key, which rotates when the engine is running, so that the motor vehicle resembles a large wind-up toy.

### BACKGROUND OF THE INVENTION

In addition to being a mode of transportation, motor vehicles are also a means of self-expression. The style and ornamentation of a car, truck or van is often a “vehicle” for the owner to express his or her individuality and personality. Nowhere are a person's tastes and preferences more openly and publicly on display than out on the road. The windows of an automobile commonly display the names or logos of organizations the owner supports or the college he or she has attended. And a people's political leanings can often be read on the rear bumper of their vehicles—often along with the name of their favorite sports teams or musical performers.

Ornamentation plays a major part in putting the owner's personal touch on his/her vehicle. The distinctive hood ornaments of a Mercedes-Benz or a Jaguar symbolize the character and prestige of those vehicles. Up to now, however, motor vehicle ornamentation has been static and motionless—somewhat of an anomaly given the mobile setting. An active, moving device adds a whole new dimension to vehicular ornamentation and opens up entirely novel avenues of self-expression.

Previous attempts to introduce the element of motion to motor vehicle ornaments have focused on wind-driven devices, as in Federico, U.S. Pat. No. D295,738, Kurilla, U.S. Pat. No. D79,728, and Bishop U.S. Pat. No. 1,755,863. But these references suffer from severe limitations on the type of ornamentation that can function in this setting. Such ornaments must necessarily be light and embody aerodynamic features such as propellers or airfoils in order to be sustained in motion by wind alone.

For the foregoing reasons, there is a need for a motor vehicle ornament that is capable of movement independent of wind forces.

### SUMMARY OF THE INVENTION

The present invention is directed to a motor vehicle ornament which rotates about its central axis. The means for imparting rotational motion to the ornament may be a small electric motor or a clock-type spring driven mechanism. Due to the greater and more constant rotational torque available in this configuration, the moving ornament can be larger and heavier than would be feasible using the prior art. Moreover, the ornament need not embody airfoil-like contours, but can embody virtually any design elements—from the standard hood ornament to more exotic and whimsical devices.

A rotating motor vehicle ornament having features of the present invention comprises three principal parts. First, it has a ornament member, which consists of an ornamental element—that is, the ornament itself—and a base element on which the ornament is mounted. Attached to the bottom of the base element and aligned with its central axis is the upper end of a shaft member, the lower end of which is coupled to a motor member, which is a means for imparting rotational motion through the shaft to the ornament member. This means may be a small electric motor which may be battery powered or may be connected to the vehicle's electrical system. Alternately, the motor member may consist of a spring-driven mechanism such as those found in clocks and watches. Such a spring mechanism could employ self-winding features which are presently known in the art relating to timepieces.

Attached to the lower end of the motor member is an anchor member, the under side of which is an attachment element comprising a means of securing the anchor member to the body of a motor vehicle. This means may be nut-and-bolt or screw type fasteners, and may incorporate quick-release features such as are known in the art, thereby enabling the ornament to be readily removed. Alternately, the means of securing the anchor member to the vehicle body may be a spring-loaded key mechanism such as that disclosed in Tedrahn, U.S. Pat. No. 4,913,941, or such equivalent devices that are known in the art whereby the ornament may be readily attached and removed from the vehicle body. Alternately, the means of securing the anchor member 16 to the vehicle body may be a powerful magnet.

In the preferred embodiment, the ornamental element is in the form of a wind-up key, resembling those which are used on wind-up toys and music-boxes. Rotational torque is provided by an electric motor which is electrically connected to the alternator of the motor vehicle, such that the wind-up key rotates when the engine is running. This combination results in the motor vehicle resembling a large wind-up toy with its wind-up key turning as it moves.

### BRIEF DESCRIPTION OF THE DRAWING

FIG. 1 is a front view of a rotating motor vehicle ornament embodying the features of the present invention.

### DESCRIPTION OF THE INVENTION

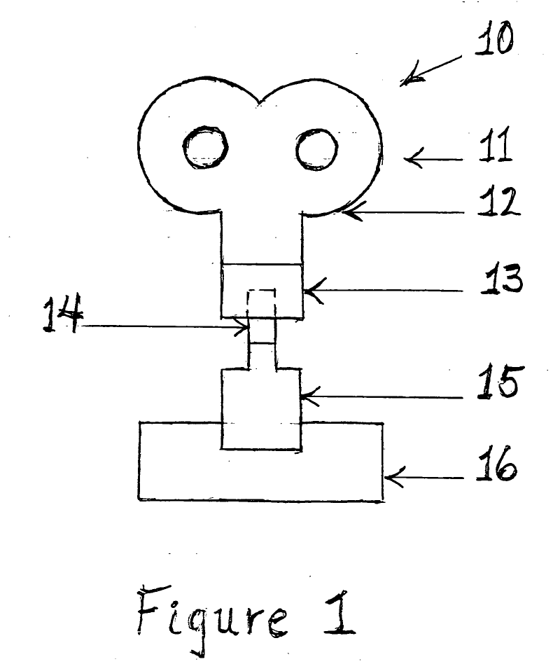

As shown in FIG. 1, a rotating motor vehicle ornament embodying the features of the present invention 10 comprises an ornament member 11 having an ornamental element 12 and a base element 13. Axially disposed to the bottom of the base element and connected to it is the upper end of a shaft member 14. The lower end of the shaft member 14 is coupled to a motor member 15 comprising a means for imparting rotational motion through the shaft member 14 to the ornament member 11. This means may be a small electric motor which may be battery powered or may be connected to the vehicle's electrical system. Alternately, the motor member 15 may consist of a spring-driven mechanism such as those found in clocks and watches. Such a spring mechanism could employ self-winding features which are presently known in the art relating to timepieces.

Attached to the lower end of the motor member 15 is an anchor member 16, the under side of which is an attachment element (not shown) comprising a means of securing the anchor member 16 to the body of a motor vehicle (not shown). This means may be nut-and-bolt or screw type fasteners, and may incorporate quick-release features such as are known in the art, thereby enabling the ornament 10 to be readily removed. Alternately, the means of securing the anchor member 16 to the vehicle body may be a spring-loaded key mechanism such as that disclosed in Tedrahn, U.S. Pat. No. 4,913,941, or such equivalent devices that are known in the art whereby the ornament 10 may be readily attached and removed from the vehicle body. Alternately, the means of securing the anchor member 16 to the vehicle body may be a powerful magnet.

In the preferred embodiment, the ornamental element 12 is in the form of a wind-up key, resembling those which are used on wind-up toys and music-boxes. Rotational torque is provided by an electric motor which is electrically connected to the alternator of the motor vehicle (not shown), such that the wind-up key 12 rotates when the engine is running. This combination results in the motor vehicle resembling a large wind-up toy with its wind-up key turning as it moves.

The material used to fabricate the ornamental element 12 must be coordinated with the power source of the motor member 15. When an electric motor is used, a heavier material such as stainless steel or chrome-plated steel may be used to fabricate the ornamental element 12. When a spring-driven mechanism is employed, a lighter material such a plastic may be preferable. In the preferred embodiment, the wind-up key ornamental element 12 should be sized proportionally to the size of the vehicle so as to conform to the image of a large wind-up toy. Accordingly, the preferred embodiment will provide for a range of sizes of wind-up keys 12 corresponding to different sizes of vehicles.

The operator of the invention 10 finds a suitable location on the vehicle to attach the secure the anchor member 16 using the attachment element (not shown). In the preferred embodiment, the wind-up key 12 is most suitably attached to the rear or trunk, where such keys are typically located on wind-up toy vehicles. In the latter location, the electric motor 15 could then be wired to the vehicle's electrical system through the trunk or cargo space of the vehicle, in the same way as brake lights on a trailer hitch are electrically connected.

The present invention is, therefore, well adapted to satisfy the need for a moving motor vehicle ornament which can accommodate a wide variety of ornamental designs and materials.

While the present invention has been described is some detail with reference to certain currently preferred embodiments, other embodiments are feasible and will readily suggest themselves to those skilled in the art. Therefore, the spirit and scope of the appended claims is not limited to the description of the preferred embodiment contained herein.

What if claimed is:

1. A rotating motor vehicle ornament comprising:
(a) an ornament member having an ornamental element and a base element;
(b) a shaft member having an upper end which is axially connected to the base element of the ornament member and a lower end which is coupled to a motor member comprising a means for rotating the shaft member, thereby causing the ornament member to rotate; and
(c) an anchor member having an upper side which is attached to the motor member and a under side consisting of an attachment element comprising a means for securing the anchor member to the body of a motor vehicle.

2. The rotating motor vehicle ornament according to claim 1, wherein the means for rotating the shaft member is an electric motor.

3. The rotating motor vehicle ornament according to claim 2, wherein the electric motor is electrically connected to the alternator of the motor vehicle such that the ornament member rotates only when the engine of the motor vehicle is running.

4. The rotating motor vehicle ornament according to any one of claims 1-3, wherein the attachment element further comprises a means for disengaging the anchor member from the body of the motor vehicle, thereby allowing the rotating motor vehicle ornament to be temporarily removed.

5. The rotating motor vehicle ornament according to any one of claims 1-3, wherein the ornamental element is in the shape of a wind-up key, such that the motor vehicle to which it is attached resembles a large wind-up toy.

6. The rotating motor vehicle ornament according to claim 4, wherein the ornamental element is in the shape of a wind-up key, such that the motor vehicle to which it is attached resembles a large wind-up toy.
